(19) United States
(12) Patent Application Publication
(10) Pub. No.: US 2026/0064942 A1
(43) Pub. Date: Mar. 5, 2026

(54) Guided User Interface for Facilitating Generation of Asset-Descriptive Electronic Document with Images

(71) Applicant: Inspectagram Inc., Calgary (CA)

(72) Inventor: Lucas KIRSCH, Calgary (CA)

(21) Appl. No.: 18/821,838

(22) Filed: Aug. 30, 2024

(51) Int. Cl. G06F 40/166; G06F 3/0482; G06F 3/04886; G06T 11/60; H04N 23/63

(52) U.S. Cl. CPC G06F 40/166; G06F 3/0482; G06F 3/04886; G06T 11/60; H04N 23/632; G06T 2200/24

(57) ABSTRACT

Computer program products, systems and methods provide a guided user interface on a mobile computing device for generating an asset-descriptive electronic document (e.g., an inspection report or a brochure) with image and text components depicting and describing an asset. In one method, a touchscreen of a mobile computing device display a document generation interface having image placeholder areas. In response to detecting a touch input at one of the image place holder areas, the touchscreen displays an image acquisition interface, which may be a digital camera interface. The touchscreen displays an updated document generation interface with an image acquired using the image acquisition interface and positioned in the touched mage placeholder areas. The asset-descriptive electronic document is generated and stored, with at least a portion of the updated document generation interface being a what-you-see-is what-you-get (WYSIWYG) representation of at least a portion of the generated asset-descriptive electronic document.

### FIELD OF THE DISCLOSURE

This disclosure relates to computer program products, systems and methods that provide a guided user interface on a mobile computing device for generating an asset-descriptive electronic document (e.g., an inspection report or a brochure) with image and text components depicting and describing an asset (e.g., a house).

### BACKGROUND OF THE DISCLOSURE

There is a need in to create documents that include both image and text depicting and describing an asset, such as an inspection report for a house or an industrial asset (e.g., a pipeline or a refinery), or a sales brochure for a house or vehicle. Dedicated software applications (or “apps”) for smartphones for generating inspection reports provide guided user interfaces that allow the user to capture photographs using the smartphone digital camera and enter descriptive text. However, these interfaces do not resemble the final inspection report, and therefore make it difficult for the user to ensure that the inspection report will appear as intended and to assess progress on completing the inspection report. Further, such inspection apps may use the smartphone's native digital camera application, which may capture photographs that are improperly formatted for the inspection report. Consequently, the captured photographs may not display properly within the generated inspection report, or the user may need to post-process the photograph to fit geometric constraints of the inspection report. There remains a need in the art for guided user interfaces on mobile computers that improve the speed and convenience with which a user can generate a document describing an asset with image and text components.

In aspects, the present disclosure comprises a computer program product, a related system, and a related method for facilitating a user in generating an asset-descriptive electronic document.

In a first aspect, the present disclosure comprises a method for facilitating a user in generating an asset-descriptive electronic document. The method is implemented by a processor comprising at least a processor of a mobile computing device comprising a touchscreen and a digital camera. The method comprises:
displaying, on the touchscreen, a document generation interface comprising a plurality of spatially distributed image placeholder areas, wherein each one of the image placeholder areas is responsive to a touch input on the one of the image placeholder areas to display, on the touchscreen, a respective image acquisition interface;
in response to detecting the touch input at a first one of the image placeholder areas, displaying, on the touchscreen, a first image acquisition interface for acquiring a first image for the first one of the image placeholder areas,
   wherein the first image acquisition interface comprises either:
   a first digital camera interface that enables the user to actuate the digital camera to capture the first image, or
   a first image selection interface that enables the user to select the image from a plurality of stored images;
displaying, on the touchscreen, an updated document generation interface comprising the document generation interface with the first image acquired using the first image acquisition interface and positioned in the first one of the image placeholder areas; and
generating and storing the asset-descriptive electronic document, wherein at least a portion of the updated document generation interface is a what-you-see-is what-you-get (WYSIWYG) representation of at least a portion of the generated asset-descriptive electronic document when the asset-descriptive electronic document is rendered on a display screen of a computing device.

In embodiments of the method of the first aspect, the first image acquisition interface comprises the first digital camera interface.

In embodiments of the method of the first aspect in which the first image acquisition interface comprises the first digital camera interface, an aspect ratio of the first one of the image placeholder areas may differ from an aspect ratio of a second one of the image placeholder areas. The first digital camera interface may enable the user to actuate the digital camera to capture the first image with an aspect ratio that is substantially equal to the aspect ratio of the first one of the image placeholder areas, and comprises a first digital camera live view area that has an aspect ratio that is substantially equal to the aspect ratio of the first one of the image placeholder areas. The method may further comprise:
in response to detecting the touch input at the second one of the image placeholder areas, displaying, on the touchscreen, a second image acquisition interface for acquiring a second image for the second one of the image placeholder areas, wherein the second image acquisition interface comprises a second digital camera interface that enables the user to actuate the digital camera to capture the second image with an aspect ratio that is substantially equal to the aspect ratio of the second one of the image placeholder areas, and comprises a second digital camera live view area that has an aspect ratio that is substantially equal to the aspect ratio of the second one of the image placeholder areas; and
displaying, on the touchscreen, the updated document generation interface comprising the document generation interface with the second image acquired using the second image acquisition interface and positioned in the second one of the image placeholder areas.

The mobile computing device may comprise an orientation sensor. In embodiments of the method of the first aspect in which the first image acquisition interface comprises the first digital camera interface, the first one of the image placeholder areas may have a predefined aspect ratio having a value other than unity. The first digital camera interface may comprise a digital camera live view area. The method may further comprise:
detecting, using the orientation sensor, a first orientation of the mobile computing device relative to a horizontal reference orientation;
based on the detected first orientation of the mobile computing device, configuring the digital camera live view area on the touchscreen so that an aspect ratio of the first digital camera live view area is substantially equal to the predefined aspect ratio when the mobile computing device is in the detected first orientation;
detecting, using the orientation sensor, a second orientation of the mobile computing device relative to a horizontal reference orientation, wherein the second orientation is different from the first orientation; and
based on the detected second orientation of the mobile computing device, configuring the digital camera live view area on the touchscreen so that the aspect ratio of the digital camera live view area is substantially equal to the predefined aspect ratio when the mobile computing device is in the detected second orientation.

In embodiments of the method of the first aspect, the image acquisition interface comprises the image selection interface.

In embodiments of the method of the first aspect, the document generation interface may comprise a plurality of spatially distributed text placeholder areas, wherein each one of the text placeholder areas is responsive to a touch input on the one of the text placeholder areas to display, on the touchscreen, a respective text acquisition interface. The method may further comprise, before the generating and storing of the asset-descriptive electronic document:
in response to detecting a touch at the first one of the text placeholder areas, displaying, on the touchscreen, a first text acquisition interface for acquiring a text entry for the first one of the text placeholder areas, wherein the text acquisition interface comprises either:
   a text entry interface comprising a virtual keyboard that enables the user to type the text entry, or
   a text selection interface that enables a user to select the text entry from a plurality of stored text entries; and
displaying, on the touchscreen, the updated document generation interface comprising the text entry acquired using the text entry interface and positioned in the first one of the text placeholder areas.

In embodiments of the method of the first aspect, the text acquisition interface comprises the text entry interface. In embodiments of the method, the text acquisition interface comprises the text selection interface.

In a second aspect, the present disclosure comprises a method for facilitating a user in generating an asset-descriptive electronic document comprising a first image having a predefined first aspect ratio and a second image having a predefined second aspect ratio differing from the predefined first aspect ratio. The method is implemented by a processor comprising at least a processor of a mobile computing device comprising a touchscreen and a digital camera. The method comprises:
displaying, on the touchscreen, a document generation interface enabling the user to activate a first digital camera interface and a second digital camera interface,
   wherein the first digital camera interface enables the user to actuate the digital camera to capture the first image with an aspect ratio that is substantially equal to the predefined first aspect ratio, and comprises a first digital camera live view area having an aspect ratio that is substantially equal to the first predefined aspect ratio; and
   wherein the second digital camera interface enables the user to actuate the digital camera to capture the second image with an aspect ratio that is substantially equal to the predefined second aspect ratio, and comprises a second digital camera live view area having an aspect ratio that is substantially equal to the second predefined aspect ratio; and
displaying the first digital camera interface, and in response to the user actuating the digital camera using the first digital camera interface, capturing the first image;
displaying the second digital camera interface, and in response to the user actuating the digital camera using the second digital camera interface, capturing the second image; and
generating and storing the asset-descriptive electronic document comprising the first image or an image based thereon, and the second image or an image based thereon.

The mobile computing device may comprise an orientation sensor. In embodiments of the method of the second aspect, the predefined first aspect ratio has a value other unity, and the method further comprises:
detecting, using the orientation sensor, a first orientation of the mobile computing device relative to a horizontal reference orientation;
based on the detected first orientation of the mobile computing device, configuring the first digital camera live view area on the touchscreen so that the aspect ratio of the first digital camera live view area is substantially equal to the predefined first aspect ratio when the mobile computing device is in the detected first orientation;
detecting, using the orientation sensor, a second orientation of the mobile computing device relative to a horizontal reference orientation, wherein the second orientation is different from the first orientation; and
based on the detected second orientation of the mobile computing device, configuring the first digital camera live view area on the touchscreen so that the aspect ratio of the first digital camera live view area is substantially equal to the predefined first aspect ratio when the mobile computing device is in the detected second orientation.

In embodiments of the method of the second aspect, the detected first orientation and the detected second orientation are separated by about 90° of rotation of the mobile computing device about a horizontal axis.

In other aspects, the present disclosure comprises a computer program product for facilitating a user in generating an asset-descriptive electronic document. The computer program product is tangibly embodied in at least one non-transitory computer readable storage medium and comprises instructions executable by at least one processor comprising at least a processor of a mobile computing device comprising a touchscreen and a digital camera, to implement a method of the first aspect or a method of the second aspect as described above.

In other aspects, the present disclosure comprises a system for facilitating a user in generating an asset-descriptive electronic document. The system comprises a mobile computing device comprising a touchscreen, a digital camera and optionally an orientation sensor, a processor comprising at least a processor of the mobile computing device, and at least one non-transitory computer readable storage medium comprising instructions executable by at least one processor to implement a method of the first aspect or a method of the second aspect as described above.

### BRIEF DESCRIPTION OF THE DRAWINGS

The foregoing and other aspects of the disclosure will be better appreciated with reference to the attached drawings, in which like reference characters denote like parts, as follows.

FIG. 1 is a schematic depiction of mobile computing devices that display the guided user interface of the present disclosure for facilitating generation of asset-descriptive electronic documents (ADEDs), in network communication with a server computer used to store ADEDs and additional computing devices used to review ADEDs.

FIG. 2 is a functional block diagram of an embodiment of a system of the present disclosure for facilitating generation of an ADED.

FIGS. 3 and 4 collectively show a flow chart of an embodiment of a method of the present disclosure implemented by the system of FIG. 2 for facilitating generation of an ADED. FIG. 3 shows a first portion of the flow chart. FIG. 4 shows a second portion of the flowchart.

FIG. 5 shows an embodiment of a portion of a document generation interface of the present disclosure, as it appears on a touchscreen of a mobile computing device.

FIG. 6 shows a first portion of the document generation interface of FIG. 5 at an enlarged scale, showing a first image placeholder area.

FIG. 7 shows an embodiment of a first digital camera interface of the present disclosure for acquiring an image for the first image placeholder area in FIG. 6, as it appears on a touchscreen of a mobile computing device.

FIG. 8 shows an embodiment of an image selection interface of the present disclosure for acquiring an image for the first image placeholder area in FIG. 6, as it appears on a touchscreen of a mobile computing device.

FIG. 9 shows a second embodiment of an image acquisition interface of the present disclosure for acquiring an image for the first image placeholder area in FIG. 6, as it appears on a touchscreen of a mobile computing device.

FIG. 10A shows another portion of the document generation interface of FIG. 5, as it appears on a touchscreen of a mobile computing device. FIG. 10B shows an embodiment of an interface of the present disclosure for accessing a third embodiment of an image selection interface for acquiring an image for the first placeholder area in FIG. 6, as it appears on a touch screen of a mobile computing device. FIG. 10C shows a third embodiment of an image selection interface of the present disclosure for acquiring an image for an image placeholder area in FIG. 10A, as it appears on a touchscreen of a mobile computing device.

FIG. 11 shows an embodiment of an evaluation interface of the present disclosure, as it appears on a touchscreen of a mobile computing device.

FIG. 12 shows an embodiment of a text acquisition interface of the present disclosure, as it appears on a touchscreen of a mobile computing device.

FIG. 13 shows the text acquisition interface of FIG. 12 including a text entry interface, as it appears on a touchscreen of a mobile computing device.

FIG. 14 shows the text acquisition interface of FIG. 12 including a text selection interface, as it appears on a touchscreen of a mobile computing device.

FIG. 15 shows an embodiment of an updated document generation interface of the present disclosure, as it appears on a touchscreen of a mobile computing device.

FIG. 16 shows a second portion of the document generation interface of FIG. 5 at an enlarged scale, as it appears on a touchscreen of a mobile computing device.

FIG. 17 shows an embodiment of a second digital camera interface for acquiring an image for a second image placeholder area in FIGS. 5 and 15, on a touchscreen of a mobile computing device in a portrait orientation relative to a horizontal reference orientation.

FIG. 18 shows the second digital camera interface of FIG. 17 on the touchscreen of a mobile computing device in a landscape orientation relative to a horizontal reference orientation.

FIG. 19 shows an embodiment of a publishing interface of the present disclosure for a user to indicate that image and text entries for an asset-description electronic document are complete, as it appears on a touchscreen of a mobile computing device.

FIG. 20 shows an embodiment of a portion of an asset-descriptive electronic document of the present disclosure, generated by the computer program product of the present disclosure, as it appears on a touchscreen of a mobile computing device or a screen of a computing device.

### DETAILED DESCRIPTION OF EXAMPLE EMBODIMENTS

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise explained, all technical and scientific terms used herein have the same meaning as commonly understood by one of ordinary skill in the art to which this disclosure belongs.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”. The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. It will be understood that any embodiments described as “comprising” certain components may also “consist of” or “consist essentially of” these components, wherein “consisting of” has a closed-ended or restrictive meaning and “consisting essentially of” means including the components specified but excluding other components except for components added for a purpose other than achieving the technical effects described herein.

It will be understood that any component defined herein as being included may be explicitly excluded from the claimed invention by way of proviso or negative limitation, such as any specific components or method steps, whether implicitly or explicitly defined herein.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

“Attached”, as used herein, in describing the relationship between two connected parts includes the case in which the two connected parts are “directly attached” with the two connected parts being in contact with each other, and the case in which the connected parts are “indirectly attached” and not in contact with each other, but connected by one or more intervening other part(s) between.

“Memory”, as used herein, refers to a non-transitory tangible computer-readable medium for storing information (e.g., data or data structures) in a format readable by a processor, and/or instructions (e.g., computer code or software programs or modules) that are readable and executable by a processor to implement an algorithm. The term “memory” includes a single device or a plurality of physically discrete, operatively connected devices despite use of the term in the singular. Non-limiting types of memory include solid-state semiconductor, optical, magnetic, and magneto-optical computer readable media. Examples of memory technologies include optical discs such as compact discs (CD-ROMs) and digital versatile (or video) discs (DVDs), magnetic media such as floppy disks, magnetic tapes or cassettes, and solid state semiconductor random access memory (RAM) devices, read-only memory (ROM) devices, electrically erasable programmable read-only memory (EEPROM) devices, flash memory devices, memory chips and combinations of the foregoing. Memory may be non-volatile or volatile. Memory may be physically attached to a processor, or remote from a processor. Memory may be removable or non-removable from a system including a processor. Memory may be operatively connected to a processor in such a way as to be accessible by a processor. Instructions stored by a memory may be based on a plurality of programming and/or markup languages known in the art, with non-limiting examples including the C, C++, C #, Python™, MATLAB™, Java™, JavaScript™, Perl™, PHP™, SQ ™, Visual Basic™, Hypertext Markup Language (HTML), Extensible Markup Language (XML), and combinations of the foregoing programming languages. Instructions stored by a memory may also be implemented by configuration settings for a fixed-function device, gate array or programmable logic device.

“Processor”, as used herein, refers to one or more electronic hardware devices that is/are capable of reading and executing instructions stored on a memory to perform operations on data, which may be stored on a memory or provided in a data signal. The term “processor” includes a single device or a plurality of physically discrete, operatively connected devices despite use of the term in the singular. The plurality of processors may be arrayed or distributed. Non-limiting examples of processors include integrated circuit semiconductor devices and/or processing circuit devices referred to as computers, servers or terminals having single or multi-processor architectures, microprocessors, microcontrollers, microcontroller units (MCU), central processing units (CPU), field-programmable gate arrays (FPGA), application specific circuits (ASIC), digital signal processors, and combinations of the foregoing.

Any method, application or module herein described may be implemented using computer readable/executable instructions that may be stored or otherwise held by a memory and executed by a processor. Aspects of the present disclosure may be described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments of the disclosures described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

### Overview

The present disclosure relates to computer program products and related systems and methods that provide a guided user interface on a mobile computing device for facilitating a user in generating an asset-descriptive electronic document that, in embodiments, includes image and text components.

“Asset-descriptive electronic document” or “ADED” as used herein refers to a electronic file containing data that can be rendered by a computing device in human-readable form on a display screen (e.g., a display screen of a mobile computing device, a laptop computer, or a desktop computer), which data may encode images that depict an asset and text that describes the asset. The ADED is not limited by the nature of the asset. As non-limiting examples, the asset may be a house or other building, a vehicle (e.g., an automobile), an industrial facility (e.g., a refinery, or a pipeline), or industrial equipment (e.g., a machine). The ADED is not limited by the intellectual significance of the image and text components that depict and describe the asset. As non-limiting examples, the ADED may be an inspection report for an asset (e.g., a house, vehicle, or equipment), or a brochure for an asset (e.g., a sales brochure for marketing a house, vehicle, or equipment). The ADED is not limited by a particular file format or language in which it is stored.

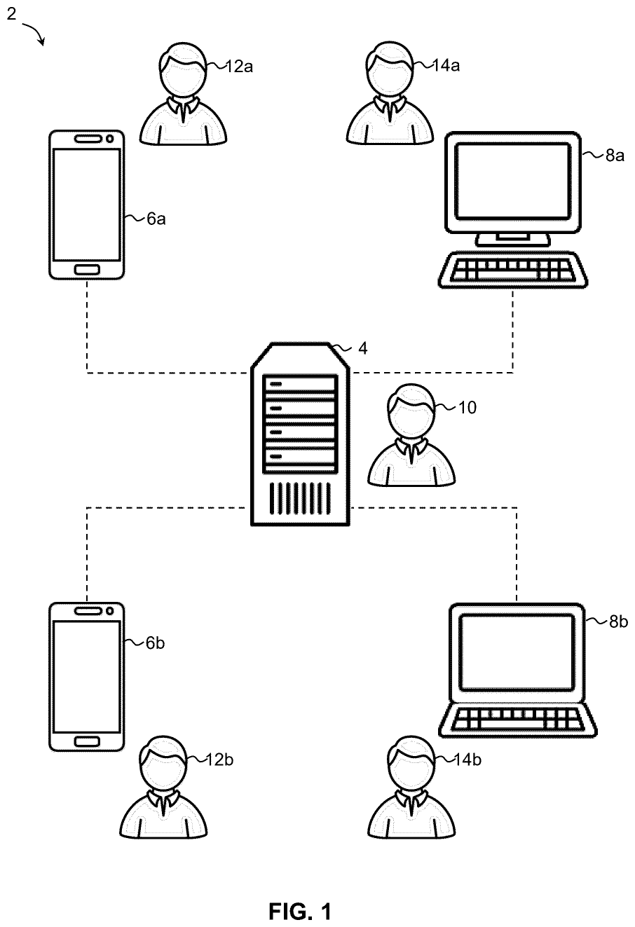

FIG. 1 shows an embodiment of a system 2 of the present disclosure that is used for generating an ADED in the form of an electronic house inspection report. In the embodiment shown in FIG. 1, the system 2 includes a server computer 4, at least one mobile computing device 6a, 6b (generally 6), and at least one computing device 8a, 8b (generally 8). The server computer 4 is in communication with the at least one mobile computing device 6a, 6b and the at least one computing device 8a, 8b via a communications network (e.g., the Internet) as shown by dashed lines, which may comprise a wireless communication network (e.g., networks that operate in accordance with cellular and/or Wi-Fi communication protocols) and/or wired communication networks (e.g., copper cable and/or optical fiber networks). The server computer 4 may be in communication with more than one mobile computing device 6a, 6b and/or more than one computing device 8a, 8b in a many-to-one server-client relationship.

In the embodiment shown in FIG. 1, the user 10 of the server computer 4 may be an administrator of the system 2, such as a software-as-a-service (SaaS) provider. The server computer 4 is a computer comprising a processor, a memory and a network connection (e.g., an Internet modem). In embodiments, the server computer 4 may be used as an application server to host part of the instructions of the computer program product of the present disclosure that facilitates generation of ADEDs as described below. In embodiments, the server computer 4 may be used as a file server to host data for ADEDs that are generated using the computer program product as described below.

In the embodiment shown in FIG. 1, the user 12a, 12b of each of mobile computing devices 6a, 6b, respectively, may be a person involved in preparing the ADED. As non-limiting examples, such persons may be involved with inspecting or selling an asset (e.g., house or vehicle inspectors and salespersons). Such persons may be affiliated with each other via shared electronic accounts that allow them to collaborate with each other to prepare the ADED. “Mobile computing device”, as used herein, refers to a portable computing device that comprises a processor, a memory, a touchscreen, a digital camera and a wireless modem (e.g., cellular and/or Wi-Fi modem) for communicating with a wireless communications network. In the embodiment shown in FIG. 1, the mobile computing device 6a or 6b is a device commonly known as a smartphone or a tablet computer, such as those that operate using the iOS (™) mobile operating system (Apple Inc.) or the Android (™) mobile operating system (Google LLC). In other embodiments, a mobile computing device 6 may be a portable laptop computer, such as those that operate using the Microsoft Windows (™) operating system (Microsoft Corporation) or the macOS (™) operating system (Apple Inc.). In embodiments, the memory of the mobile computing device 6a or 6b may store part or all of the instructions of the computer program product of the present disclosure that facilitates collection of data for generation of ADEDs as described below. It will be appreciated that the mobile computing devices 6a, 6b may or may not be in communication via the communication with the server computer 4 while the mobile computing devices 6a, 6b are used to collect data used to generate the ADED. In some exemplary uses, the mobile computing devices 6a, 6b may be operated in an “offline mode” in which the data collected using the mobile computing devices 6a, 6b to generate the ADED is not transmitted to the server computer 4 until the user provides a command to do so. In other exemplary uses, the mobile computing devices 6a, 6b may be operated in an “online mode” in which they automatically transmit data collected to generate the ADED in continuously or periodically in real time (i.e., within a short time such as a second, a few seconds, or a minute of the data being collected) via the communications network to the server computer 4. In such an “online mode”, the mobile computing devices 6a, 6b may also continuously receive, in real time, updated data for generating the ADED from the server computer 4 and display such data on a document generation interface as described below. Accordingly, the users 12a, 12b of two mobile computing devices 6a, 6b may operate collaboratively so that each user 12a, 12b of their respective mobile computing device 6a, 6b can independently collect data for generating the ADED, and, in real time, view on the document generation interface the data collected by the other user 12b, 12a using the other mobile computing device 6b, 6a. Thus, for example, each of a plurality of users 12a, 12b (or more) may simultaneously inspect different parts for a house, and be aware of which parts have already been inspected by the other user 12b, 12a.

In the embodiment shown in FIG. 1, the user 14a, 14a of each computing devices 8a, 8b may be a person who reviews the ADED. As a non-limiting example, such persons may be a prospective purchaser of the asset, or their agent, lender, or appraiser, or an asset manager. Alternatively, such person may be the same person as one of the users 12a, 12b involved in preparing the ADED or a coordinator or supervisor of such person. In embodiments where data for the ADED is hosted or stored on the server computer 4, the computing device 8a may have permission to access such data via the communications network, and make changes to the data to further prepare or finalize the ADED and to transmit instructions via the communications network to publish the ADED via the communications network in a non-editable form to the mobile computing devices 6a, 6b and/or another computing device 8b. Each computing device comprises a processor, a memory, a display screen, and a network connection (e.g., an Internet modem). In the embodiment shown in FIG. 1, the computing devices are shown as desktop and laptop computers (e.g., computers that operate using the Microsoft Windows (™) operating system (Microsoft Corporation) or the macOS (™) operating system (Apple Inc.), but may alternatively be implemented by a smartphone or a tablet computer as described above for the mobile computing devices 6a, 6b.

### System and Computer Program Product

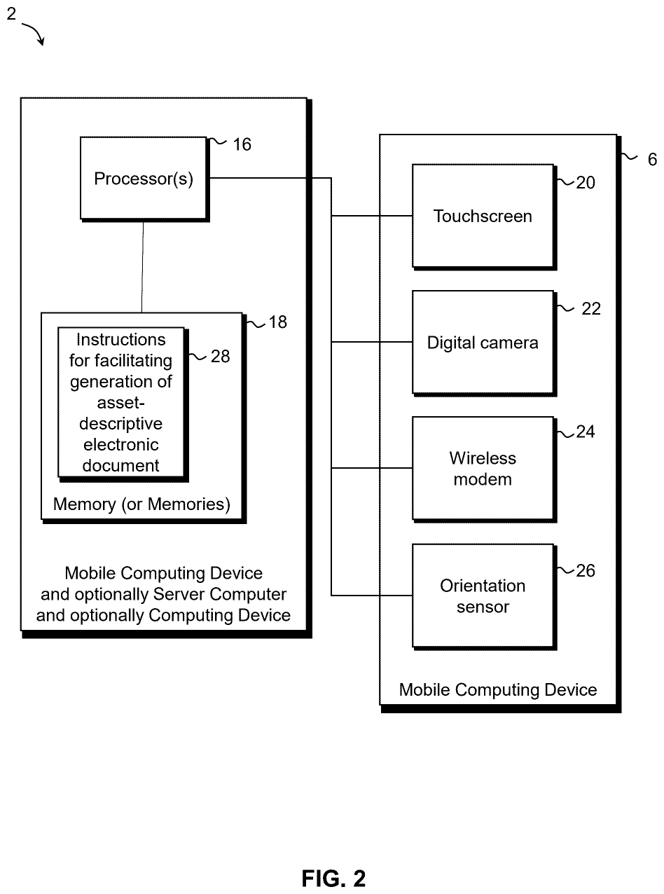

FIG. 2 shows a functional block diagram of a system 2 of the present disclosure. The system 2 comprises at least one processor 16 and at least one memory 18. The system 2 also comprises at least one mobile computing device 6 comprising a touchscreen 20, a digital camera 22, and a wireless modem 24 (e.g., cellular and/or Wi-Fi modem), as described above. In the embodiment shown, the mobile computing device 6 may also comprise an orientation sensor 26 (e.g., a mechanical gyroscope sensor and/or an accelerometer, which in embodiments may be implemented by microelectromechanical systems (MEMS) devices) for detecting the orientation of the mobile computing device 6—e.g., whether the touchscreen 20 of the mobile computing device 6 is in a portrait orientation in which the major dimension of the mobile computing device is substantially parallel to a horizontal reference orientation or a landscape orientation in which the major dimension of the mobile computing device is substantially perpendicular to the horizontal reference orientation.

The at least one processor 16 is operatively connected with the components of the mobile computing device 6 for controlling their operation and processing and/or communicating data that is generated, received, and/or processed by the components of the mobile computing device 6. The at least one memory 18 stores instructions 28 that are implemented by the at least one processor 16 for facilitating generation of asset-descriptive electronic documents as described below, and constitutes a computer program product of the present disclosure.

The at least one processor 16 and the at least one memory 18 are implemented at least partly or entirely by the processor and the memory that are onboard (i.e., contained within) one of the mobile computing device 6. In embodiments, the at least one processor 16 and the at least one memory 18 may be further implemented partly by the processor and the memory of the server computer 4, and/or the computing device 8. Accordingly, the instructions 28 for generating the ADED may be stored either entirely by the memory of the mobile computing device 6, or partly by the memory of the mobile computing device 6 and partly by the memory of the server computer 4 and/or the computing device 8; and the instructions 28 for facilitating the generation of the ADED may be implemented either entirely by the processor of the mobile computing device 6, or partly by the processor of the mobile computing device 6 and partly by the processor of the server computer 4 and/or the computing device 8. The instructions 28 or portions thereof of the computer program product for facilitating the generation of the ADED may be downloaded (e.g., via the App Store (™) platform (Apple Inc.), or the Google Play (™) platform (Google LLC) and installed as a software application or “app” on the mobile computing device 6.

### Method for Facilitating a User in Generating of an ADED

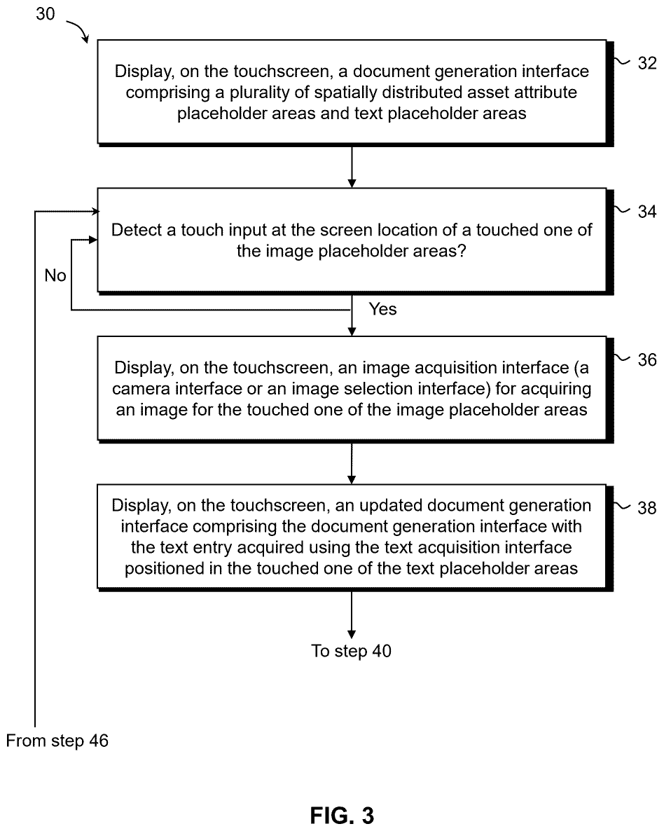

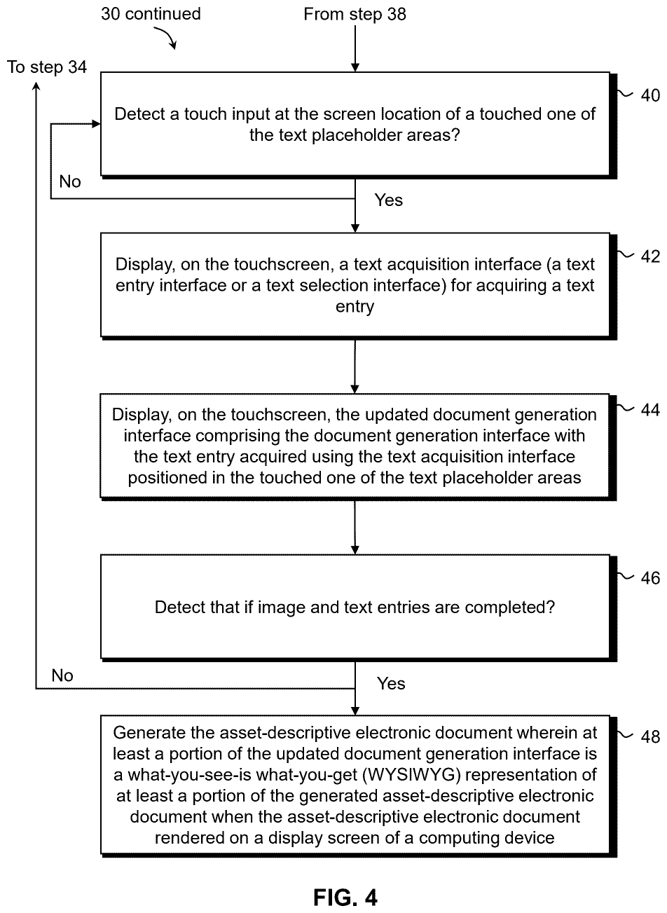

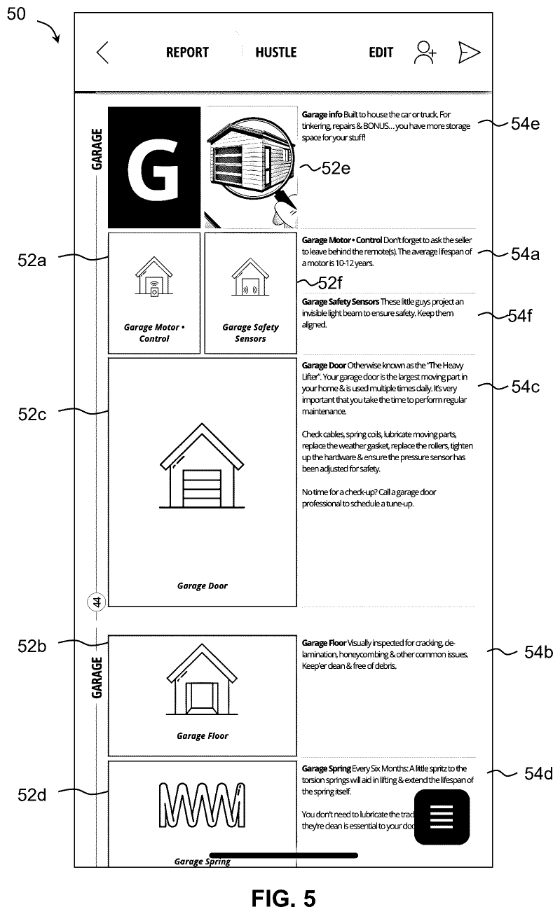

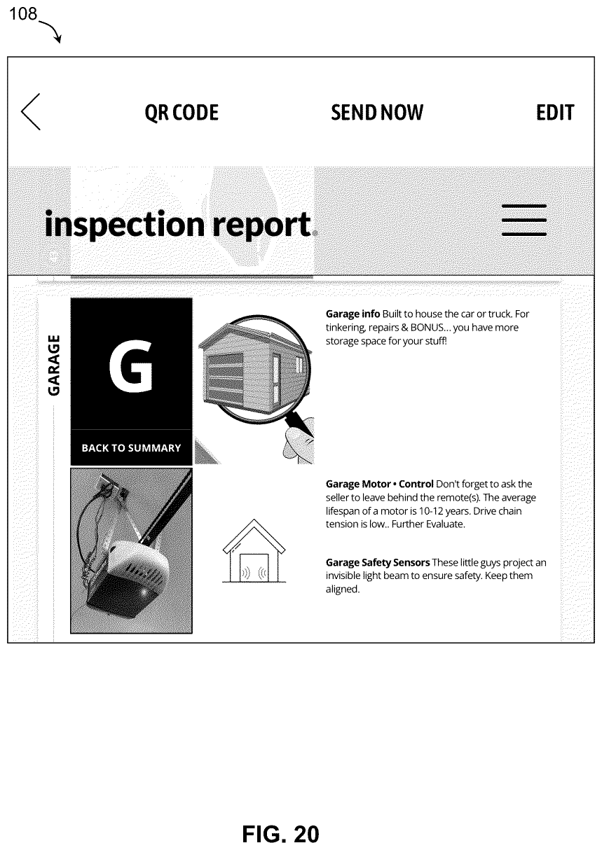

The at least one processor 16 executes the instructions 28 that are stored on the at least one memory 18 (i.e., the computer program product of the present disclosure) to implement a method 30 for facilitating a user in generating an ADED. An embodiment of the method 30 is described below with respect to the flow chart of the method 30 shown in FIGS. 3 and 4, aspects of an embodiment of a guided user interface shown in FIGS. 5 to 19 that are displayed on the touchscreen 20 of a mobile computing device 6 when implementing the method 30, and an embodiment of an ADED 108 as shown in FIG. 20 which is generated by the method 30 when rendered on the display screen of a mobile computing device 6 or a computing device 8.

Referring to FIG. 3, at step 32 of the method 30, the touchscreen 20 of the mobile computing device 6 displays a document generation interface 50, a portion of which is shown in one embodiment in FIG. 5. The document generation interface 50 comprises a plurality of spatially distributed asset attribute placeholder areas. The computer program product may select the document generation interface 50 customized for a particular type of asset that is the subject of the ADED, from a database library of different document generation interfaces, which may be preprogrammed and/or created by the user. In this example, each asset attribute placeholder area corresponds to a component of a house that is the subject of the ADED to be generated by the method 30. In FIG. 5, the portion of the document generation interface 50 pertains more specifically to parts of a garage of the house. The user may scroll up and down on the touchscreen 20 to view other portions of the document generation interface 50 that pertain to different parts of the house. Accordingly, the document generation interface 50 allows a user (e.g., a home inspector) to conveniently review parts of the ADED and assess which asset attribute placeholder areas have been completed and which still require completion for generating the ADED.

In this embodiment, each asset attribute placeholder area comprises image placeholder areas 52a to 52f (generally 52), each of which is paired with a text placeholder area 54a to 54f (generally 54) generally adjacent to the image placeholder area 52. In this embodiment, each image placeholder area 52 and each text placeholder area 54 is displayed as a rectangular region on the touchscreen 20. In other embodiments, the image placeholder areas 52 and the text placeholder areas 54 may have different shapes and arrangements on the touchscreen 20. As will be illustrated below, each image placeholder area 52a to 52f is responsive to a touch input on the one of the image placeholder areas 52a to 52f to display, on the touchscreen, a respective image acquisition interface (i.e., an image acquisition interface that corresponds to the particular image placeholder area). Similarly, each text placeholder area 54a to 54f is responsive to a touch input on the one of the text placeholder areas 54a to 54f to display, on the touchscreen, a respective text acquisition interface (i.e., a text acquisition interface that corresponds to the particular image placeholder area).

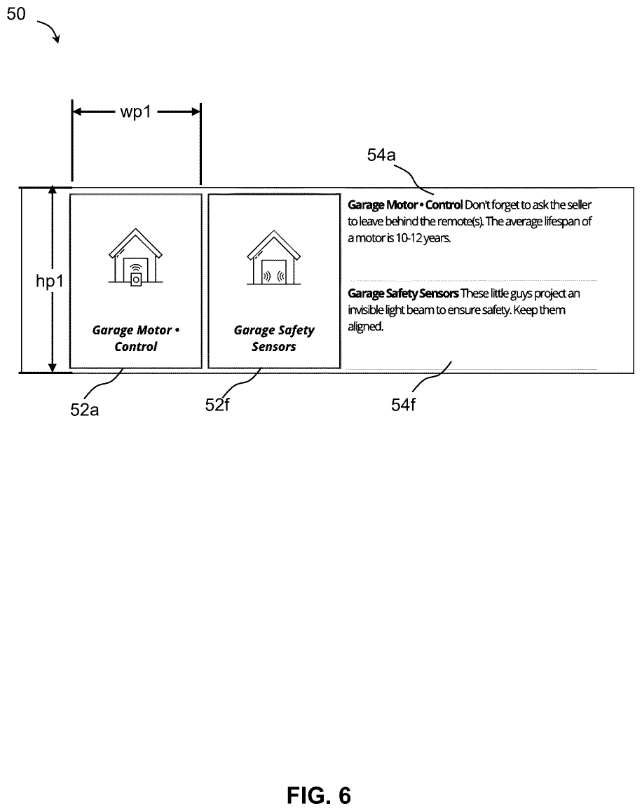

At step 34 of the method 30, the mobile computing device 6 detects a touch input at a touched one of the image placeholder areas 52 (e.g., a one of the image placeholder areas 52 that has been touched by the user using a finger or stylus). The “no” loop of the flowchart at step 34 indicates that the method 30 may continue to await a touch input at one of the image placeholder areas 52 until such a touch input is detected. The following example supposes that the user has touched a first image placeholder area 52a labelled as “Garage Motor Control”, which is shown in FIG. 5 and at enlarged scale in FIG. 6.

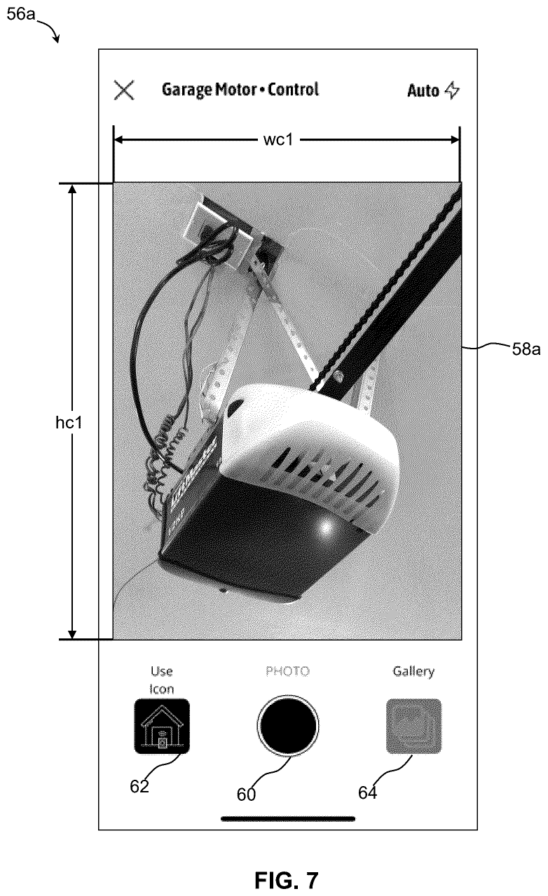

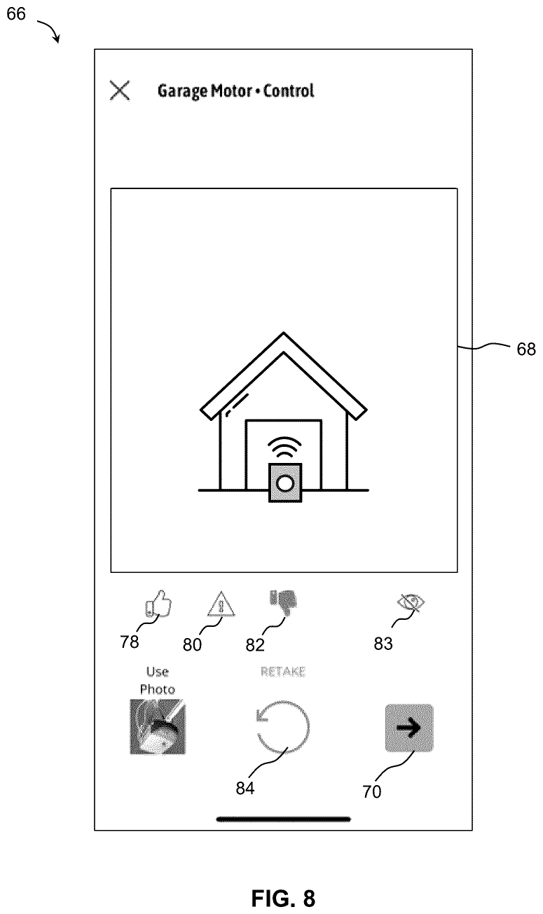

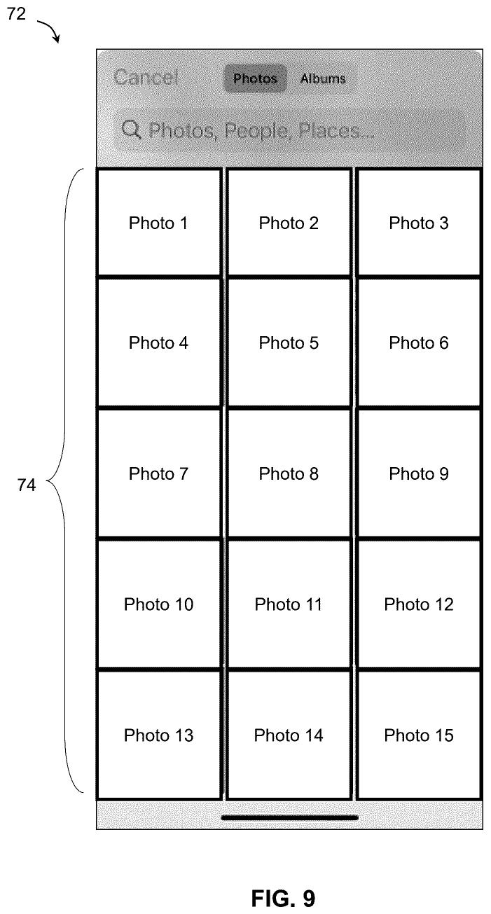

At step 36 of the method 30, in response to detecting a touch input at the first image placeholder area 52a, the touchscreen 20 of the mobile computing device 6 displays an image acquisition interface for acquiring an image for the touched first image placeholder area 52a. The image acquisition interface can comprise a digital camera interface 56 (FIG. 7) or an image selection interface (FIG. 8 or FIG. 9) as discussed below.

FIG. 7 shows an embodiment of a digital camera interface 56 for acquiring an image for the first image placeholder area 52a labelled as “Garage Motor Control”. The digital camera interface 56a comprises a digital camera live view area 58a that dynamically displays, in real time, an image detected by the sensor of the digital camera 22 of the mobile computing device 6 depending on where the digital camera sensor is directed. In the example of FIG. 7, the digital camera 22 is capturing an image of a garage door motor. The digital camera interface 56a also enables the user to actuate the digital camera 22 to capture the image shown in the digital camera live view area 58a. For example, in the embodiment shown in FIG. 7, the digital camera interface 56a comprises a virtual button 60 labelled “PHOTO”, which when touched by the user, actuates the digital camera 22 to capture the image shown in the digital camera live view area 58a.

As an alternative to using the digital camera interface 56a, the user may use an image selection interface to acquire the image for the touched one of the image placeholder areas 52. The embodiment of the digital camera interface 56a shown in FIG. 7 includes a virtual button 62 labelled “Use Icon” and another virtual button 64 labelled “Gallery. If the user touches the virtual button 62 labelled “Use Icon”, then the touchscreen 20 of the mobile computing device 6 shows the embodiment of the image selection interface 66 shown in FIG. 8 that allows the user to select a predefined icon as displayed in a viewing area 68 for the image to be inserted into the first image placeholder area 52a, by pressing the virtual button 70 labelled with an arrow. Alternatively, if the user touches the virtual button 64 labelled “Gallery” in FIG. 7, then the touchscreen 20 of the mobile computing device 6 shows the embodiment of the image selection interface 72 shown in FIG. 9, which allows the user to select (e.g., by touch selection on the touchscreen 20) an image from a plurality of images 74 (labelled as “Photo 1” through “Photo 15” in FIG. 9) that are stored in a memory accessible to the mobile computing device 6 (e.g., the memory of the mobile computing device 6, or the memory of a cloud storage accessed via a communications network) to be inserted into the first image placeholder area 52a. Such images may be photos that the user has previously captured that may depict components or show graphical and/or textual information relevant to the asset attribute. For example, in embodiments where the mobile computing device 6 is a smartphone operating on the iOS (™) mobile operating system (Apple Inc.) or the Android (™) mobile operating system (Google LLC), the images 74 may be populated from a photo gallery comprising locally and/or remotely stored image files.

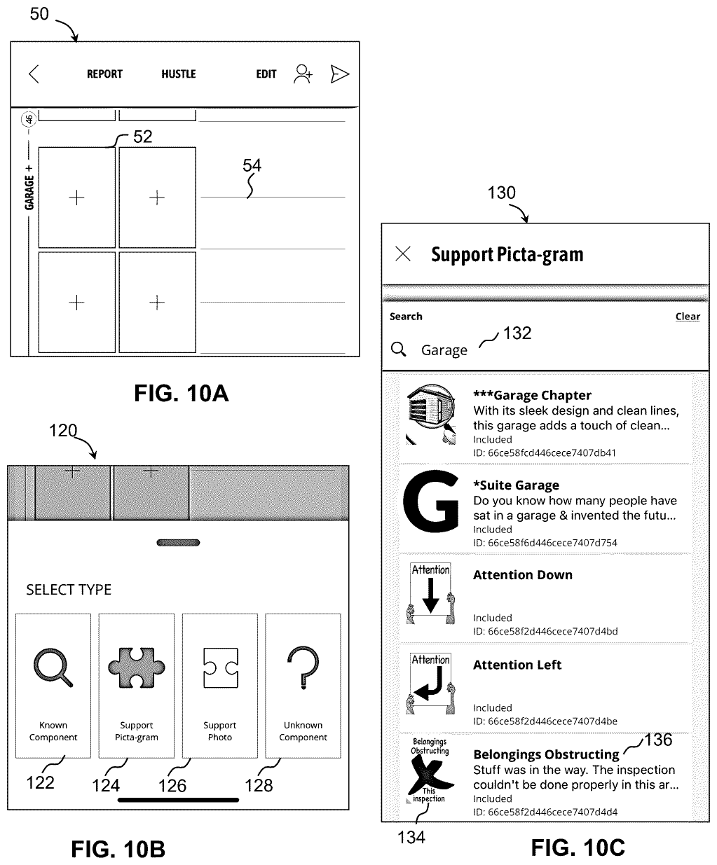

FIGS. 10A to 10C illustrate yet another way in which the user may acquire an image for a touched one of the image placeholder areas. FIG. 10A shows a different portion of the document generation interface of FIG. 5. Each of the rectangular regions marked with a plus “+” sign is an image placeholder area 52, and the adjacent area to the right is a paired text placeholder area 54. In response to detecting a touch input at the image placeholder area 54, the bottom of the touchscreen 20 of the mobile computing device 6 displays the interface 120 shown in FIG. 10B. The interface 120 shown in FIG. 10B has virtual buttons 122 to 128. User selection of the virtual button 122 labelled “Known Components” causes the touchscreen 20 to display another interface (not shown) in which the user may search and select among predefined parts of an asset (e.g., the garage components as shown in FIG. 5). User selection of the virtual button 126 labelled “Support Photo” or the virtual button 128 labelled “Unknown Component” causes the touchscreen 20 to display a digital camera interface (not shown) similar to that shown in FIG. 7. User selection of the virtual button 124 labelled “Support Picta-gram” causes the touchscreen to display the image selection interface 120 as shown in FIG. 10C. In FIG. 10C, the user may use the text entry window 132 to enter a search parameter relating to a part of an asset, such as a “garage” in this example. In response to the search, the image selection interface 120 displays a plurality of predefined images relating to a garage, each of which is paired with a text entry. These predefined images and text entries are used to support the user in populating the image placeholder areas 52 and text placeholder areas 54. For example, the user may select the predefined image 134 and its paired predefined text 136 titled “Belongings Obstructing” by touching them on the touchscreen 20. In response to such selection, the touchscreen 20 shows the document generation interface shown in FIG. 10A, updated with the predefined image 132 and the predefined text 134 inserted into the image placeholder area 52 and text placeholder area 134, respectively.

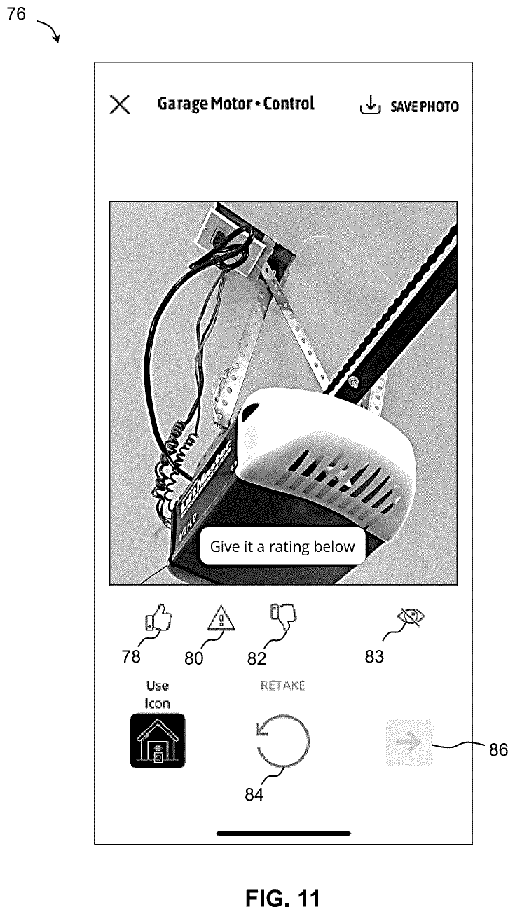

To continue the present example, suppose that the user has used the digital camera interface 56a of FIG. 7 to capture an image of a garage motor controller shown in the digital camera live area 58a. After touching the virtual button labelled “PHOTO” in FIG. 7 to capture the image, the touchscreen 20 of the mobile computing device 6 displays an evaluation interface 76 as shown in one embodiment in FIG. 11. In this embodiment, the evaluation interface 76 shows the captured image, and a set of virtual buttons labelled with icons (a virtual button 78 labelled with thumbs up icon; a virtual button 80 labelled with caution symbol icon; a virtual button 82 labelled with thumbs down icon, and a virtual button 83 labelled with a struck-through eye icon) that are selectable by the user to apply an evaluation to the asset attribute. For example, the thumbs up, caution symbol, thumbs down and struck-through eye icons indicate the asset attribute is acceptable, requires attention, requires immediate attention, or not observed respectively, or these icons may be user programmable to assign different customized meanings to them. This embodiment of the evaluation interface 76 also has a virtual button 84 labeled “RETAKE”, which may be touched to return the touchscreen 20 to the digital camera interface 56a of FIG. 7. (The image selection interface shown in FIG. 8 also includes an evaluation interface having the same set of virtual buttons, and it will be understood that a similar evaluation interface 76 may be displayed on the touchscreen 20 if the user selects one of the predefined images using the image selection interface of FIG. 9.)

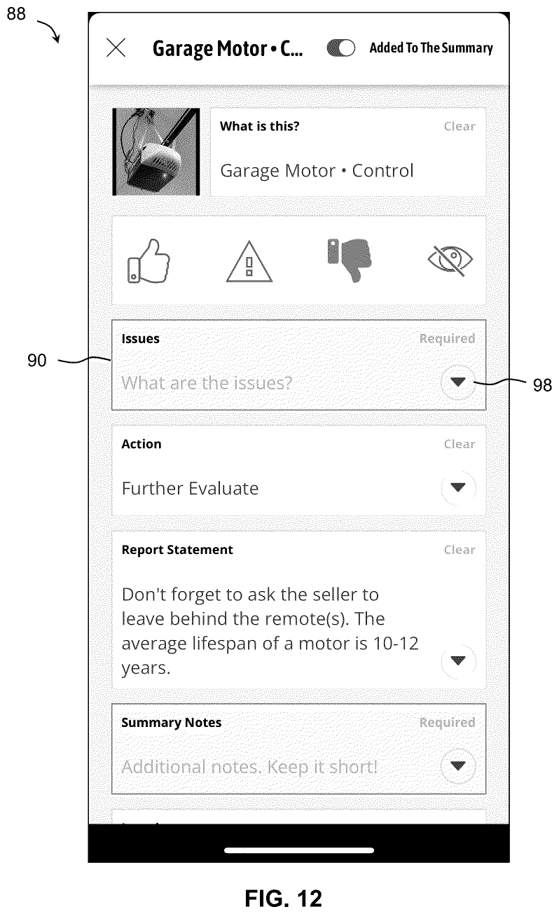

The embodiment of the evaluation interface 76 shown in FIG. 11 has a virtual button 86 labelled with an arrow that becomes activated after the user has applied an evaluation to the asset attribute by touching one of the virtual buttons 78, 80, 82. In response to the mobile computing device 6 detecting a touch input to the virtual button 86 labelled with an arrow, the touchscreen 20 of the mobile computing device 6 displays a text acquisition interface 88 for acquiring a text entry, which is shown in one embodiment in FIG. 12, as discussed below.

Alternatively, referring back to FIG. 4, at step 40 of the method 30, the mobile computing device 6 may detect a touch input at one of the text placeholder areas 54 (e.g., a one of the text placeholder areas 54a to 54f that has been touched by the user using a finger or stylus). The “no” loop at step 40 indicates that the method 30 may continue to await a touch input at the screen location of one of the text placeholder areas 54 until such a touch input is detected. The following example supposes that the user has touched the first text placeholder area 54a labelled as “Garage Motor Control”, which is shown in FIG. 5 and at enlarged scale in FIG. 6.

At step 42 of the method 30, in response to detecting a touch input at the first text placeholder area 54a, the touchscreen 20 of the mobile computing device 6 displays a text acquisition interface 88 for acquiring a text entry for the touched one of the text placeholder areas 54. The text acquisition interface 88 can comprise a text entry interface or a text selection interface as discussed below.

FIG. 12 shows an embodiment of a text acquisition interface 88 that is shown on the touchscreen 20 in response to detecting a touch input for the image placeholder area 52a labelled as “Garage Motor Control”. In this embodiment, the text acquisition interface 88 has a plurality of fields, such as fields labelled “Issues”, “Action”, “Report Statement” and “Summary Notes”. Each of these fields is touch responsive to display a text entry interface.

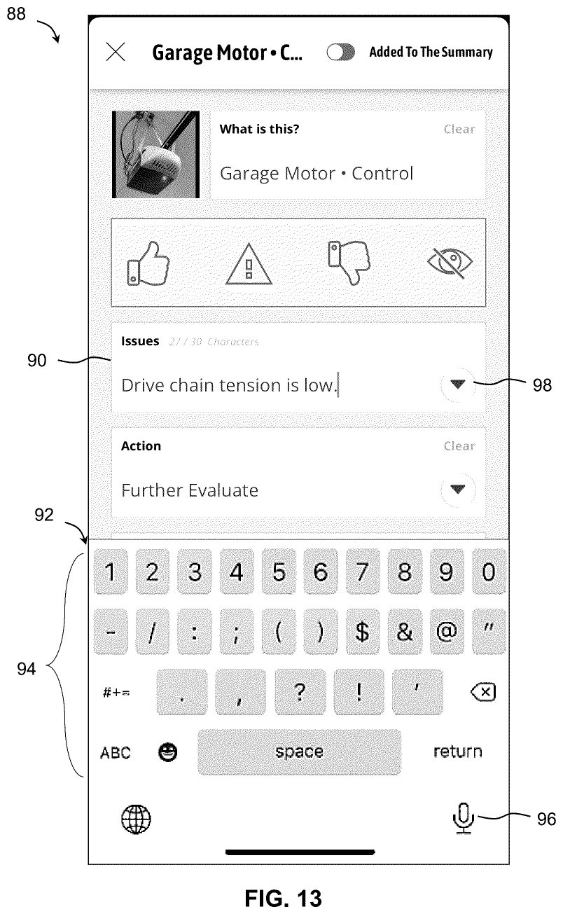

The following example supposes that the user touches the text entry field 90 labelled as “Issues” in FIG. 12. In response to this touch input, the touchscreen 20 of the mobile computing device 6 displays a text entry interface 92, which is shown in one embodiment in FIG. 13. In this embodiment, the text entry interface 92 comprises a virtual keyboard 94 that enables a user to enter a text entry into the “Issues” field to describe problems relating to the garage motor control. For example, in FIG. 13, the user has typed in the text entry “Drive chain tension is low.” The text entry interface may also comprise a speech-to-text facility activated by touching the virtual button 96 labelled with a microphone icon that transcribes the user's speech into written text.

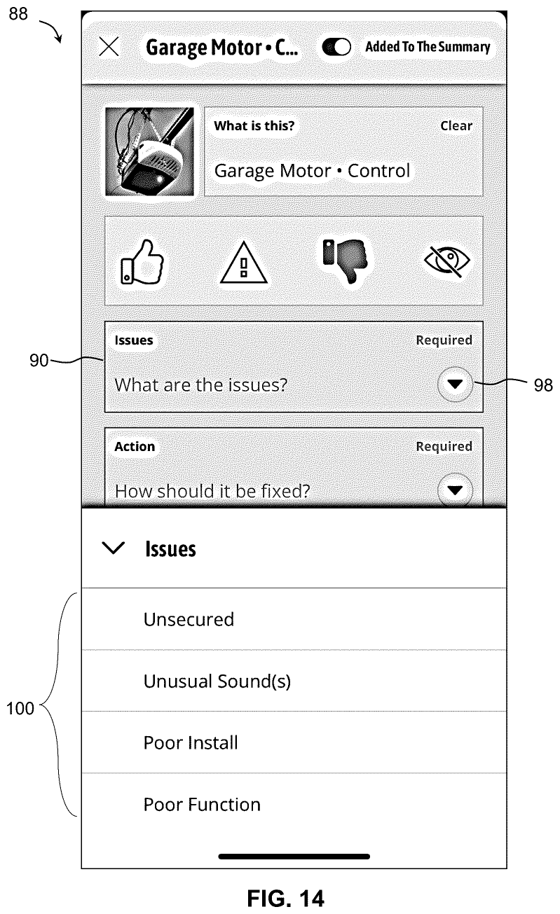

Alternatively, the following example supposes that the user touches the virtual button 98 labelled with a down arrow in the field labelled as “Issues” in FIG. 12 or FIG. 13. In response to this touch input, the touchscreen 20 of the mobile computing device 6 displays a text selection interface 88, which is shown in one embodiment in FIG. 14. In this embodiment, the text selection interface 88 comprises a drop down menu of a plurality of text entries 100 predefined and stored in the memory 18, which are labelled as “Unsecured”, “Unusual Sound(s)”, “Poor Install”, “Poor Function” and so forth. Each of these text entries is touch sensitive so as to be selectable by the user to be inserted into the “Issues” field, rapidly without the need for manual typing. These text entries 100 may be context specific to image placeholder area or the text placeholder area that was touched by the user to arrive at the text selection interface 88.

Alternatively, the image selection interface shown in FIG. 10C may also be considered to be a text selection interface insofar as it allows for section of a text entry 136.

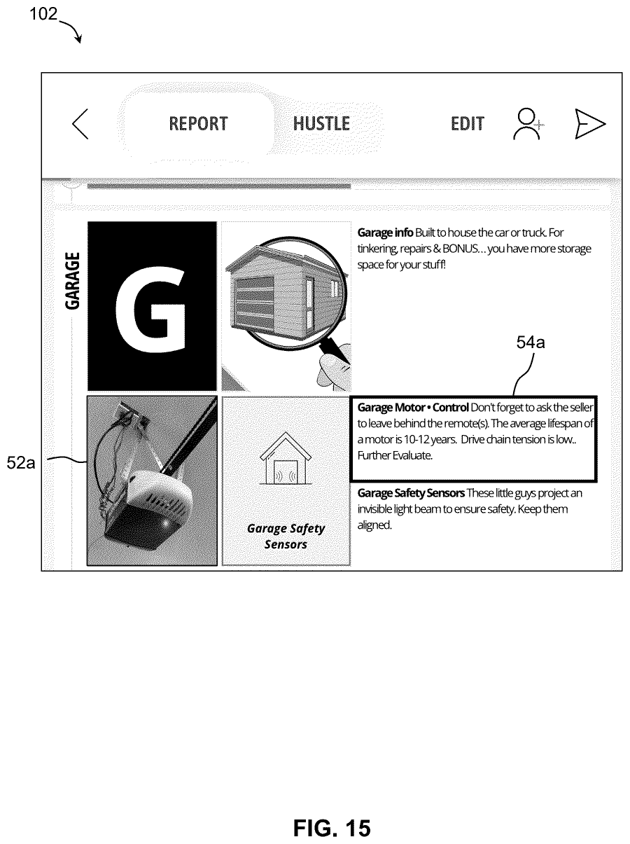

Referring back to FIGS. 3 and 4, it will be understood that steps 38 and 44, may be performed simultaneously or in different orders than shown in FIGS. 3 and 4. This example supposes that steps 38 and 44 are performed simultaneously. At step 38 and step 44, the touchscreen 20 of the mobile computing device 6 displays an updated document generation interface 102, a portion of which is shown in one embodiment in FIG. 15. The updated document generation interface 102 comprises the document generation interface 50 with the image acquired using the image acquisition interface positioned in the touched first image placeholder area 52a. In this example, referring to FIGS. 7 and 15, the image of the garage door motor captured using the digital camera interface 56a (FIG. 7) is positioned in the first image placeholder area 52a (FIG. 15). The updated document generation interface 102 also comprises the document generation interface 50 with the text entry acquired using the text acquisition interface 88 positioned in the touched one of the text placeholder areas 54a. In this example, referring to FIGS. 13 and 15, the text entry “Drive chain tension is low” (FIG. 13) is positioned in the touched first text placeholder area 54a (FIG. 15) for the garage motor placeholder area, as highlighted by the outlined region.

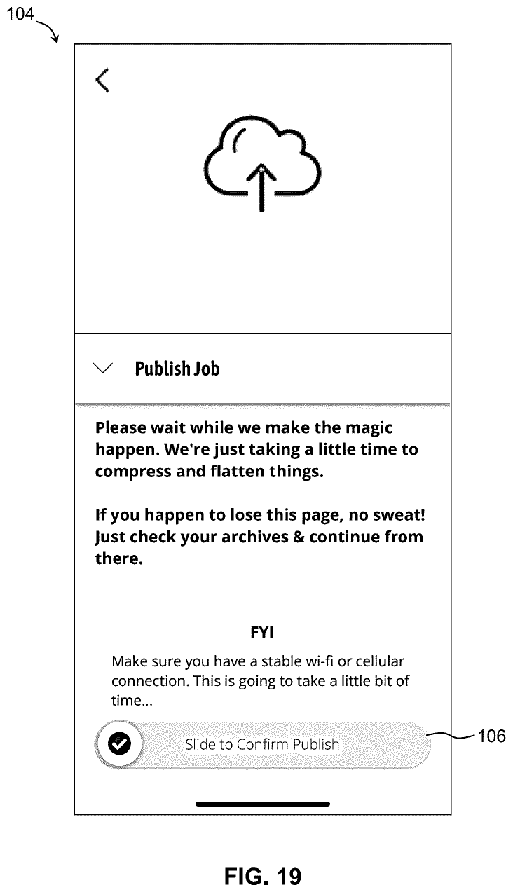

Referring back to FIG. 4, at step 46 of the method 30, the processor 16 detects if the image and text entries for the image placeholder areas 52 and text placeholder areas 54, respectively, of the document generation interface 50 are completed. In one embodiment, the detection of the image and text entries for the document generation interface 50 being completed may be indicated by a user input, as discussed below with reference to FIG. 19.

If they are not completed, then the method 30 returns to step 34 (FIG. 3) so that images and text entries for other image placeholder areas 52 and text placeholder areas 54, respectively, of the document generation interface 50 can be completed.

Referring back to FIG. 5, in this example, suppose that the user touches a second image placeholder area 52b labelled “Garage Floor”, which is shown at an enlarged scale in FIG. 15. Steps 34 to 46 may be repeated in respect to this second image placeholder area 52b and its associated text placeholder area 54b, in the same manner as described above in respect to the first image placeholder area 52a and its associated text placeholder area 54a.

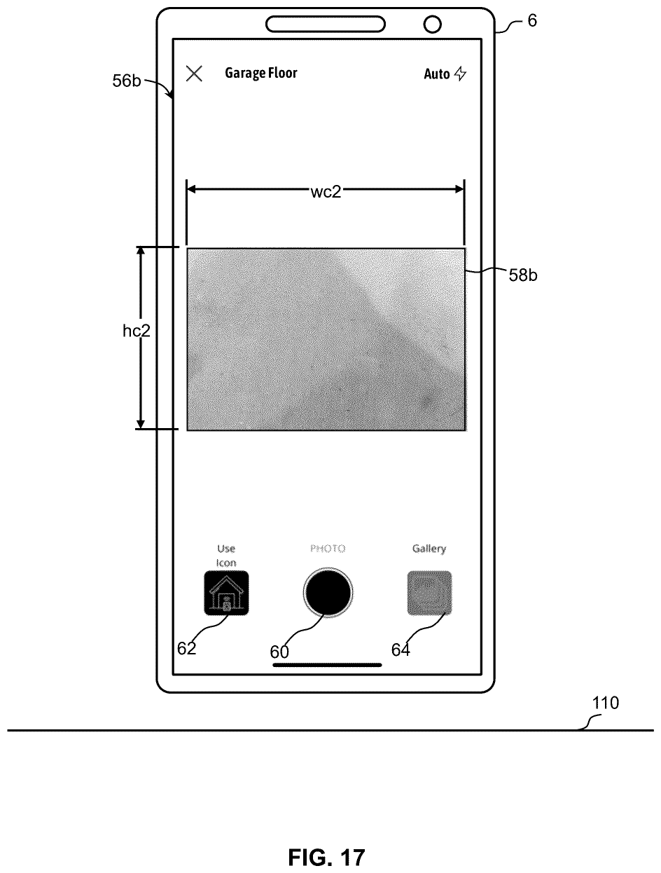

In the embodiments shown, however, attention is drawn to differences between the first digital camera interface 56a shown in FIG. 7 for acquiring the image for the first image placeholder area 52a, and a second digital camera interface 56b shown in FIG. 17 for acquiring the image for the second image placeholder area 52b that is displayed in response to a detection of a touch input at the second image placeholder area 52b.

The term “aspect ratio” as used herein in describing a rectangular area refers to a dimensionless ratio of a width (w) of the rectangular area to a height (h) of the rectangular area on a display screen (e.g., the touchscreen 20 of a mobile computing device 6, or a display screen of a computing device 8). The width and the height of the rectangular area may be measured in pixels or another unit of linear dimension.

Referring to FIG. 6, the first image placeholder area 52 has a predefined first aspect ratio defined by its width (wp1) to its height (hp1) when displayed on the touchscreen 20 of the mobile computing device 6. In this example, suppose that this aspect ratio is about a non-unity value (i.e., a value other that 1) of 3:4 or 0.75. Referring to FIG. 7, the first digital camera interface 56a has a first digital camera live view area 58a having an aspect ratio defined by its width (wc1) to its height (hp1), and that aspect ratio is substantially equal to the predefined first aspect ratio; that is, the aspect ratio of (wc1):(hp1) is also about 3:4 or 0.75. Further, when the user uses the first digital camera interface 56a to capture the first image, the digital camera captures the image with the same aspect ratio of about 3:4 or 0.75. (Although the image sensor of the digital camera 22 may have a different aspect ratio, this effect may be achieved in one embodiment by the processor 16 cropping the captured image without intervention by the user 12.) Accordingly, the image that is shown in the first digital camera live view area 58a has substantially the same aspect ratio as that of the first image captured using the first digital camera interface 56a, and can be positioned in the first image placeholder area 52a without the need for cropping or distortion. In this manner, the first digital camera interface 56a facilitates the user in framing the subject (e.g., the garage door motor shown in FIG. 7) within the first digital camera live view area 58a so that the captured image of the subject will appear as intended when inserted in the first image placeholder area 52a.

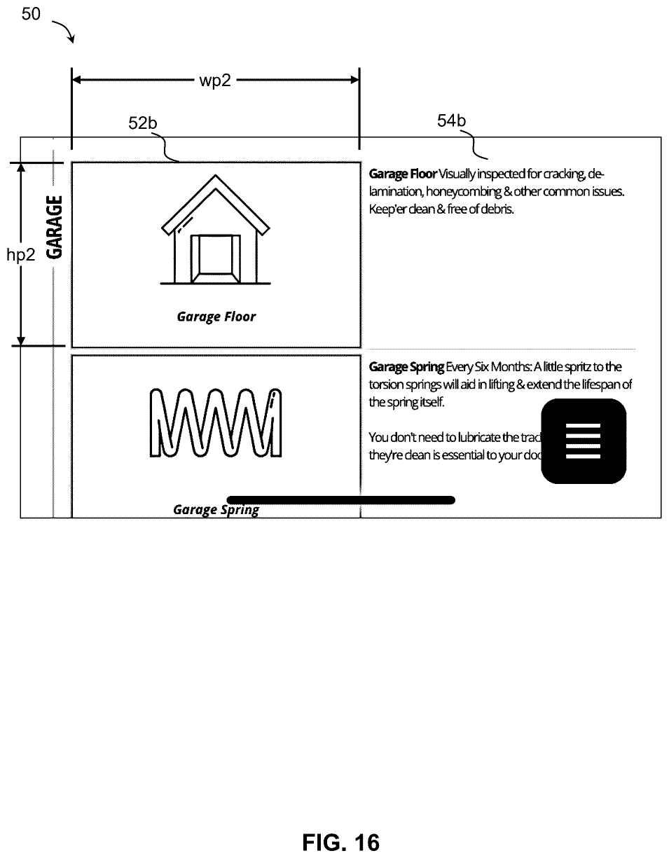

Referring to FIG. 16, the second image placeholder area 52b has a predefined second aspect ratio defined by its width (wp2) to its height (hp2). In this example, suppose that this aspect ratio is about 4:3 or 1.33, which may be more suitable than a 3:4 or 0.75 for an image of a wide expanse of a garage floor. Referring to FIG. 17, the second digital camera interface 56b has a second digital camera live view area 58b having an aspect ratio defined by its width (wc2) to its height (hp2), and that aspect ratio is substantially equal to the predefined second aspect ratio; that is, the aspect ratio of (wc2):(hp2) is also about 4:3 or 1.33. Further, when the user uses the second digital camera interface 56b to capture the second image, the digital camera 22 captures the second image with the same aspect ratio of about 4:3 or 1.33. (Again, although the image sensor of the digital camera 22 may have a different aspect ratio, this effect may be achieved in one embodiment by the processor 16 cropping the captured image without intervention by the user 12.) Accordingly, the image that is shown in the second digital camera live view area 58b also has substantially the same aspect ratio as that of the second image captured using the second digital camera interface 56b, and may positioned in the second image placeholder area 52b without cropping or distortion.

In general, it will therefore be appreciated that the digital camera interface 56a, 56b that is displayed in response to the touching of the respective one of the image placeholder areas 52a, 52b of the document generation interface 50 comprises a respective digital camera live view area 58a, 58b having an aspect ratio that substantially equal to both the aspect ratio of the image that is to captured by the digital camera 22 using the digital camera interface 56a, 56b, and to the aspect ratio of the respective image placeholder area 56a, 56b that is touched. Further, it will be appreciated that the document generation interface 50 may have different image placeholder areas 52a to 52f, some or all of which have different aspect ratios to better suit images of different intended subjects of an asset. Accordingly, some of the digital camera live view areas 58 associated with these respective image placeholder areas 52 may have aspect ratios that differ from each other. This coherence between aspect ratios of the image placeholder areas 52a, 52b in the document generation interface 50, their respective digital camera live view areas 58a, 58b, and the images captured using their respective digital camera interfaces 56a, 56b for use in the asset-descriptive electronic document to be generated helps the user to ensure that the subject of the photograph is correctly positioned within the boundaries of the asset-descriptive electronic document to be generated without guesswork by the user, and without the need for manual post-processing (e.g., cropping, zooming or rotating) of the image by the user. This makes the document generation process more convenient, efficient, and fail-safe.

In embodiments, the digital camera interface 56 may maintain the digital camera live view area 58 in an upright orientation and preserve the aspect ratio of the digital camera live view area 58 even if the mobile computing device 6 is rotated with respect to a horizontal reference orientation 110. That is, the digital camera interface 56 will show the top and bottom of the camera live view area 58 toward the top and bottom, respectively, of the touchscreen 20 with the same aspect ratio, despite rotation of the mobile computing device 6 about a horizontal axis to different orientations. In this manner, the digital camera live view area 58 continues to be substantially the same as the aspect ratio of the image placeholder area 52 that is touched even if the user has reoriented the mobile computing device 6 (e.g., the user may do so unintentionally or intentionally to hold the mobile computing device 6 more comfortably in a tight space).

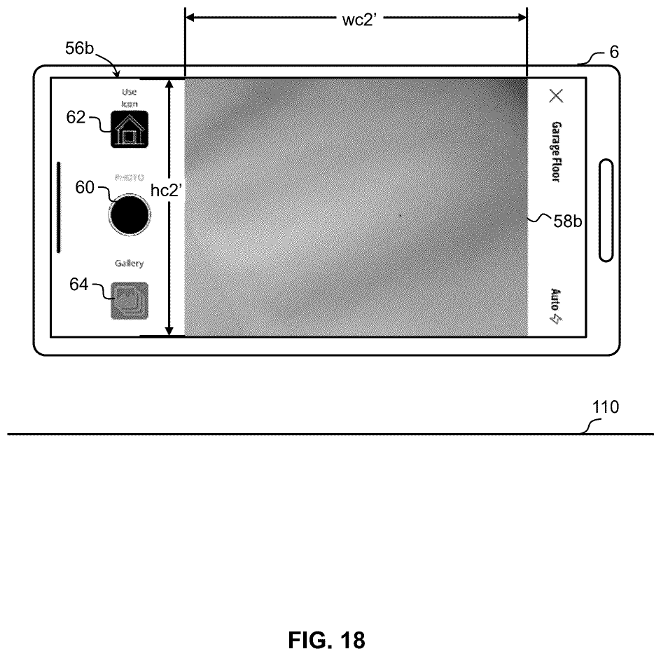

As an illustrative example, reference is made to FIGS. 17 and 18 showing the second digital camera interface 56b when the mobile computing device 6 is in a first orientation (e.g., portrait orientation shown in FIG. 17) and a second orientation (e.g., a landscape orientation shown in FIG. 18), respectively, with respect to a horizontal reference orientation 110, which are separated by about 90° of rotation about a horizontal axis. In FIG. 18, when the mobile computing device 6 is in the landscape orientation, the aspect ratio of the second digital camera live view area 58 is (wc2′):(hc2′) is substantially equal to 4:3 or 1.33, which is the same the aspect ratio (wc2):(hc2) when the mobile computing device 6 is in the portrait orientation shown in FIG. 17. Further, in both the portrait orientation (FIG. 17) and the landscape orientation (FIG. 18), the bottom of the image to be captured as shown in the digital camera live view area 58b is toward the bottom of the touchscreen 20 in its prevailing orientation.

To implement this effect, the method 30 comprises, using the orientation sensor 26 of the mobile computing device 6 to detect a change in orientation of the mobile computing device 6 relative to a horizontal reference orientation 110. Based on the detected orientation of the mobile computing device 6, the mobile computing device 6 configures the digital camera live view area 58b on the touchscreen 20 so that the aspect ratio of the digital camera live view area 58b is substantially equal to the predefined aspect ratio of the touched image placeholder area 52b when the mobile computing device 6 is in the detected orientation, for both detected orientations. In the example shown in FIGS. 17 and 18, for example, the mobile computing device 6 detects a change in orientation of the mobile computing device 6 from the portrait orientation (FIG. 17) to the landscape orientation (FIG. 18). Based on this detected change in orientation, the mobile computing device 6 reconfigures the digital camera live view area 58b from the dimensions wc2×hc2 in the portrait orientation to the dimensions wc2′×hc2′ in the landscape orientation. Further, it will be noted that despite the change in orientation of the mobile computing device 6 from the portrait orientation (FIG. 17) to the landscape orientation (FIG. 18), the top and bottom of the image displayed by the digital camera live view area 58 in either orientation, will correspond to the top and bottom, respectively, of the image when positioned in the second image placeholder area 52 of the document generation interface 50 at step 38. That is, the orientation of the captured image is preserved.

Referring back to FIG. 4, at step 46 of the method 30, as previously noted, the detection of the image and text entries for the document generation interface 50 being completed may be indicated by a user input using a publishing interface 104 as shown in one embodiment in FIG. 18. In this embodiment, the publishing interface 104 comprises a virtual button 106 labelled “Slide to Confirm Publish”, which can be touched and dragged by the user to indicate that the inputs of image and text entries to the document generation interface 50 are complete.

At step 48 of the method 30, the method 30 generates the asset-descriptive electronic document 108, which may in embodiments be a non-editable electronic document. As a non-limiting example the asset-descriptive electronic document may be a file in Portable Document Format (PDF), as known in the art, or stored in another file format. At least a portion of the updated document generation interface 102 is a what-you-see-is what-you-get (WYSIWYG) representation of at least a portion of the generated asset-descriptive electronic document 108 when the asset-descriptive electronic document 108 is rendered on a display screen of a computing device. The term “what-you-see-is what-you-get” or “WYSIWYG”, as used herein, means that the appearance of the portion of the updated document generation interface 102 substantially resembles the appearance of the portion of generated asset-descriptive electronic document 108 rendered on the display screen of the computing device in respect at least to the relative proportions and positions of their visual elements. Stated alternatively, the portion of the document generation interface 50 may be considered to be a WYSIWYG editor in that the appearance of the document generation interface 50, as it is updated, allows the user to view visual elements that will substantially resemble the appearance of the end result of the portion of generated asset-descriptive electronic document 108 rendered on the display screen of the computing device.

As an illustrative example, FIG. 20 shows an embodiment of a portion of an asset-descriptive electronic document 108 generated based on the portion of the updated document generation interface 102 shown in FIG. 15. It can be seen that the appearance of the portion of the asset-descriptive electronic document 108 corresponds substantially to the appearance of the portion of the updated document generation interface 102 including the image of the garage door motor positioned in the first image placeholder area 52 and the text entry “Drive chain tension is low” in the first text entry placeholder area. It will be understood that the asset-descriptive document may include additional content that is not shown in FIG. 20, such as a title page, a table of contents and other explanatory information that is generated under control of the computer program product.

In embodiments, the generation of the asset-descriptive electronic document 108 may be performed by the processor of the mobile computing device 6. Alternatively or additionally, the mobile computing device 6 may use its wireless modem to transmit data on which the updated document generation is based, via the communications network, to the server computer 4, and the generation of the asset-descriptive electronic document 108 may be performed by the processor 16 of the server computer 4. In embodiments, the generated asset-descriptive electronic document 108 may be stored in the memory of the mobile computing device 6 and/or the memory of the server computer 4. In embodiments, the generated asset-descriptive electronic document 108 may be distributed to (e.g., an application to a message set by email or a private messaging platform such as WhatsApp (™) (Meta Platforms, Inc. ; Menlo Park, USA) or made accessible (e.g., by generating a uniform resource locator (URL) for a web browser interface or a dedicated application, or by generating a quick-response (QR) code encoding a uniform resource locator (URL) that is decodable by a camera application to direct a browser to a webpage) to computing devices 8a, 8b via the communications network. The users of the mobile computing devices 6 and/or the computing devices 8, may also have the ability to selectively control the distribution of or access to the generated asset-descriptive electronic document 108 to or by a subset of the other users, or to retract access to the generated asset-descriptive electronic document 108 from a subset of the other users. The users of the mobile computing devices 6 and/or the computing devices 8, may also have the ability to selectively control the distribution of or access to a portion (rather than the entirety) of the generated asset-descriptive electronic document 108 to or by the other users.

Although preferred embodiments of the invention have been described herein in detail, it will be understood by those skilled in the art that variations may be made thereto without departing from the spirit of the invention or the scope of the appended claims.

### PARTS LIST

2 system
4 server computer
6 mobile computing device
8 computing device
10 user of server computer
12, 12a, 12b user of mobile computing device
14, 14a, 14b user of computing device
16 processor
18 memory
20 touchscreen
22 digital camera
24 wireless modem
26 orientation sensor
28 instructions for facilitating generation of asset-descriptive electronic document
30-48 method and steps thereof
50 document generation interface, portion of
52, 52a-f image placeholder area
54, 54a-f text placeholder area
56, 56a, 56b digital camera interface
58, 58a, 58b digital camera live view area
60 virtual button labelled “photo”
62 virtual button labelled “use icon”
64 virtual button labelled “gallery”
66 image selection interface, first embodiment
68 viewing area
70 virtual button labelled with arrow
72 image selection interface, second embodiment
74 plurality of images
76 evaluation interface
78 virtual button labelled with thumbs up icon
80 virtual button labelled with caution symbol icon
82 virtual button labelled with thumbs down icon
83 virtual button labelled with eye icon
84 virtual button labelled “RETAKE”
86 virtual button labelled with arrow
88 text acquisition interface
90 text entry field labelled “Issues”
92 text entry interface
94 virtual keyboard
96 virtual button labelled with microphone icon
98 virtual button labelled with down arrow
100 plurality of text entries
102 updated document generation interface
104 publishing interface
106 virtual button labelled “Slide to Confirm Publish”
108 asset-descriptive electronic document, portion of
110 horizontal reference orientation
120 interface for accessing image selection interface
122 virtual button labelled “Known component”
124 virtual button labelled “Support Picta-gram”
126 virtual button labelled “Support Photo”
128 virtual button labelled “Unknown Component”
130 image selection interface, third embodiment
132 text entry window for search
134 image
136 text

1. A computer program product for facilitating a user in generating an asset-descriptive electronic document, the computer program product tangibly embodied in at least one non-transitory computer readable storage medium and comprising instructions executable by at least one processor comprising at least a processor of a mobile computing device comprising a touchscreen and a digital camera, to implement a method comprising:
displaying, on the touchscreen, a document generation interface comprising a plurality of spatially distributed image placeholder areas, wherein each one of the image placeholder areas is responsive to a touch input on the one of the image placeholder areas to display, on the touchscreen, a respective image acquisition interface;
in response to detecting the touch input at a first one of the image placeholder areas, displaying, on the touchscreen, a first image acquisition interface for acquiring a first image for the first one of the image placeholder areas, wherein the first image acquisition interface comprises either:
a first digital camera interface that enables the user to actuate the digital camera to capture the first image, or
a first image selection interface that enables the user to select the image from a plurality of stored images;
displaying, on the touchscreen, an updated document generation interface comprising the document generation interface with the first image acquired using the first image acquisition interface and positioned in the first one of the image placeholder areas; and
generating and storing the asset-descriptive electronic document, wherein at least a portion of the updated document generation interface is a what-you-see-is what-you-get (WYSIWYG) representation of at least a portion of the generated asset-descriptive electronic document when the asset-descriptive electronic document is rendered on a display screen of a computing device.

2. The computer program product of claim 1, wherein the first image acquisition interface comprises the first digital camera interface.

3. The computer program product of claim 2,
wherein an aspect ratio of the first one of the image placeholder areas differs from an aspect ratio of a second one of the image placeholder areas;
wherein the first digital camera interface enables the user to actuate the digital camera to capture the first image with an aspect ratio that is substantially equal to the aspect ratio of the first one of the image placeholder areas, and comprises a first digital camera live view area that has an aspect ratio that is substantially equal to the aspect ratio of the first one of the image placeholder areas; and
wherein the method further comprises:
in response to detecting the touch input at the second one of the image placeholder areas, displaying, on the touchscreen, a second image acquisition interface for acquiring a second image for the second one of the image placeholder areas, wherein the second image acquisition interface comprises a second digital camera interface that enables the user to actuate the digital camera to capture the second image with an aspect ratio that is substantially equal to the aspect ratio of the second one of the image placeholder areas, and comprises a second digital camera live view area that has an aspect ratio that is substantially equal to the aspect ratio of the second one of the image placeholder areas; and
displaying, on the touchscreen, the updated document generation interface comprising the document generation interface with the second image acquired using the second image acquisition interface and positioned in the second one of the image placeholder areas.

4. The computer program product of claim 2, wherein the mobile computing device comprises an orientation sensor and,
wherein the first one of the image placeholder areas has a predefined aspect ratio having a value other than unity,
wherein the first digital camera interface comprises a digital camera live view area,
wherein the method further comprises:
detecting, using the orientation sensor, a first orientation of the mobile computing device relative to a horizontal reference orientation;
based on the detected first orientation of the mobile computing device, configuring the digital camera live view area on the touchscreen so that an aspect ratio of the first digital camera live view area is substantially equal to the predefined aspect ratio when the mobile computing device is in the detected first orientation;
detecting, using the orientation sensor, a second orientation of the mobile computing device relative to a horizontal reference orientation, wherein the second orientation is different from the first orientation; and
based on the detected second orientation of the mobile computing device, configuring the digital camera live view area on the touchscreen so that the aspect ratio of the digital camera live view area is substantially equal to the predefined aspect ratio when the mobile computing device is in the detected second orientation.

5. The computer program product of claim 1, wherein the image acquisition interface comprises the image selection interface.

6. The computer program product of claim 1,
wherein the document generation interface comprises a plurality of spatially distributed text placeholder areas, wherein each one of the text placeholder areas is responsive to a touch input on the one of the text placeholder areas to display, on the touchscreen, a respective text acquisition interface;
wherein the method further comprises, before the generating and storing of the asset-descriptive electronic document:
in response to detecting a touch at the first one of the text placeholder areas, displaying, on the touchscreen, a first text acquisition interface for acquiring a text entry for the first one of the text placeholder areas, wherein the text acquisition interface comprises either:
a text entry interface comprising a virtual keyboard that enables the user to type the text entry, or
a text selection interface that enables a user to select the text entry from a plurality of stored text entries; and
displaying, on the touchscreen, the updated document generation interface comprising the text entry acquired using the text entry interface and positioned in the first one of the text placeholder areas.

7. The computer program product of claim 6, wherein the text acquisition interface comprises the text entry interface.

8. The computer program product of claim 6, wherein the text acquisition interface comprises the text selection interface.

9. A system for facilitating a user in generating an asset-descriptive electronic document, the system comprising a mobile computing device comprising a touchscreen and a digital camera, a processor comprising at least a processor of the mobile computing device, and at least one non-transitory computer readable storage medium comprising instructions executable by at least one processor to implement a method comprising:
displaying, on the touchscreen, a document generation interface comprising a plurality of spatially distributed image placeholder areas, wherein each one of the image placeholder areas is responsive to a touch input on the one of the image placeholder areas to display, on the touchscreen, a respective image acquisition interface;
in response to detecting the touch input at a first one of the image placeholder areas, displaying, on the touchscreen, a first image acquisition interface for acquiring a first image for the first one of the image placeholder areas, wherein the first image acquisition interface comprises either:
a first digital camera interface that enables the user to actuate the digital camera to capture the first image, or
a first image selection interface that enables the user to select the image from a plurality of stored images;
displaying, on the touchscreen, an updated document generation interface comprising the document generation interface with the first image acquired using the first image acquisition interface and positioned in the first one of the image placeholder areas; and
generating and storing the asset-descriptive electronic document, wherein at least a portion of the updated document generation interface is a what-you-see-is what-you-get (WYSIWYG) representation of at least a portion of the generated asset-descriptive electronic document when the asset-descriptive electronic document is rendered on a display screen of a computing device.

10. The system of claim 9, wherein the first image acquisition interface comprises the first digital camera interface.

11. The system of claim 10,
wherein an aspect ratio of the first one of the image placeholder areas differs from an aspect ratio of a second one of the image placeholder areas;
wherein the first digital camera interface enables the user to actuate the digital camera to capture the first image with an aspect ratio that is substantially equal to the aspect ratio of the first one of the image placeholder areas, and comprises a first digital camera live view area that has an aspect ratio that is substantially equal to the aspect ratio of the first one of the image placeholder areas; and
wherein the method further comprises:
in response to detecting the touch input at the second one of the image placeholder areas, displaying, on the touchscreen, a second image acquisition interface for acquiring a second image for the second one of the image placeholder areas, wherein the second image acquisition interface comprises a second digital camera interface that enables the user to actuate the digital camera to capture the second image with an aspect ratio that is substantially equal to the aspect ratio of the second one of the image placeholder areas, and comprises a second digital camera live view area that has an aspect ratio that is substantially equal to the aspect ratio of the second one of the image placeholder areas; and
displaying, on the touchscreen, the updated document generation interface comprising the document generation interface with the second image acquired using the second image acquisition interface and positioned in the second one of the image placeholder areas.

12. The system of claim 10, wherein the mobile computing device comprises an orientation sensor and,
wherein the first one of the image placeholder areas has a predefined aspect ratio having a value other than unity,
wherein the first digital camera interface comprises a digital camera live view area,
wherein the method further comprises:
detecting, using the orientation sensor, a first orientation of the mobile computing device relative to a horizontal reference orientation;
based on the detected first orientation of the mobile computing device, configuring the digital camera live view area on the touchscreen so that an aspect ratio of the first digital camera live view area is substantially equal to the predefined aspect ratio when the mobile computing device is in the detected first orientation;
detecting, using the orientation sensor, a second orientation of the mobile computing device relative to a horizontal reference orientation, wherein the second orientation is different from the first orientation; and
based on the detected second orientation of the mobile computing device, configuring the digital camera live view area on the touchscreen so that the aspect ratio of the digital camera live view area is substantially equal to the predefined aspect ratio when the mobile computing device is in the detected second orientation.

13. The system of claim 9, wherein the image acquisition interface comprises the image selection interface.

14. The system of claim 9,
wherein the document generation interface comprises a plurality of spatially distributed text placeholder areas, wherein each one of the text placeholder areas is responsive to a touch input on the one of the text placeholder areas to display, on the touchscreen, a respective text acquisition interface;
wherein the method further comprises, before the generating and storing of the asset-descriptive electronic document:
in response to detecting a touch at the first one of the text placeholder areas, displaying, on the touchscreen, a first text acquisition interface for acquiring a text entry for the first one of the text placeholder areas, wherein the text acquisition interface comprises either:
a text entry interface comprising a virtual keyboard that enables the user to type the text entry, or
a text selection interface that enables a user to select the text entry from a plurality of stored text entries; and
displaying, on the touchscreen, the updated document generation interface comprising the text entry acquired using the text entry interface and positioned in the first one of the text placeholder areas.

15. The system of claim 14, wherein the text acquisition interface comprises the text entry interface.

16. The system of claim 14, wherein the text acquisition interface comprises the text selection interface.

17. A method for facilitating a user in generating an asset-descriptive electronic document, the method implemented by a processor comprising at least a processor of a mobile computing device comprising a touchscreen and a digital camera, the method comprising:
displaying, on the touchscreen, a document generation interface comprising a plurality of spatially distributed image placeholder areas, wherein each one of the image placeholder areas is responsive to a touch input on the one of the image placeholder areas to display, on the touchscreen, a respective image acquisition interface;
in response to detecting the touch input at a first one of the image placeholder areas, displaying, on the touchscreen, a first image acquisition interface for acquiring a first image for the first one of the image placeholder areas, wherein the first image acquisition interface comprises either:
a first digital camera interface that enables the user to actuate the digital camera to capture the first image, or
a first image selection interface that enables the user to select the image from a plurality of stored images;
displaying, on the touchscreen, an updated document generation interface comprising the document generation interface with the first image acquired using the first image acquisition interface and positioned in the first one of the image placeholder areas; and
generating and storing the asset-descriptive electronic document, wherein at least a portion of the updated document generation interface is a what-you-see-is what-you-get (WYSIWYG) representation of at least a portion of the generated asset-descriptive electronic document when the asset-descriptive electronic document is rendered on a display screen of a computing device.

18. The method of claim 17, wherein the first image acquisition interface comprises the first digital camera interface.

19. The method of claim 18,
wherein an aspect ratio of the first one of the image placeholder areas differs from an aspect ratio of a second one of the image placeholder areas;
wherein the first digital camera interface enables the user to actuate the digital camera to capture the first image with an aspect ratio that is substantially equal to the aspect ratio of the first one of the image placeholder areas, and comprises a first digital camera live view area that has an aspect ratio that is substantially equal to the aspect ratio of the first one of the image placeholder areas; and
wherein the method further comprises:
in response to detecting the touch input at the second one of the image placeholder areas, displaying, on the touchscreen, a second image acquisition interface for acquiring a second image for the second one of the image placeholder areas, wherein the second image acquisition interface comprises a second digital camera interface that enables the user to actuate the digital camera to capture the second image with an aspect ratio that is substantially equal to the aspect ratio of the second one of the image placeholder areas, and comprises a second digital camera live view area that has an aspect ratio that is substantially equal to the aspect ratio of the second one of the image placeholder areas; and
displaying, on the touchscreen, the updated document generation interface comprising the document generation interface with the second image acquired using the second image acquisition interface and positioned in the second one of the image placeholder areas.

20. The method of claim 18, wherein the mobile computing device comprises an orientation sensor and,
wherein the first one of the image placeholder areas has a predefined aspect ratio having a value other than unity,
wherein the first digital camera interface comprises a digital camera live view area,
wherein the method further comprises:
detecting, using the orientation sensor, a first orientation of the mobile computing device relative to a horizontal reference orientation;
based on the detected first orientation of the mobile computing device, configuring the digital camera live view area on the touchscreen so that an aspect ratio of the first digital camera live view area is substantially equal to the predefined aspect ratio when the mobile computing device is in the detected first orientation;
detecting, using the orientation sensor, a second orientation of the mobile computing device relative to a horizontal reference orientation, wherein the second orientation is different from the first orientation; and
based on the detected second orientation of the mobile computing device, configuring the digital camera live view area on the touchscreen so that the aspect ratio of the digital camera live view area is substantially equal to the predefined aspect ratio when the mobile computing device is in the detected second orientation.

21. The method of claim 17, wherein the image acquisition interface comprises the image selection interface.

22. The method of claim 17,
wherein the document generation interface comprises a plurality of spatially distributed text placeholder areas, wherein each one of the text placeholder areas is responsive to a touch input on the one of the text placeholder areas to display, on the touchscreen, a respective text acquisition interface;
wherein the method further comprises, before the generating and storing of the asset-descriptive electronic document:
in response to detecting a touch at the first one of the text placeholder areas, displaying, on the touchscreen, a first text acquisition interface for acquiring a text entry for the first one of the text placeholder areas, wherein the text acquisition interface comprises either:
a text entry interface comprising a virtual keyboard that enables the user to type the text entry, or
a text selection interface that enables a user to select the text entry from a plurality of stored text entries; and
displaying, on the touchscreen, the updated document generation interface comprising the text entry acquired using the text entry interface and positioned in the first one of the text placeholder areas.

23. The method of claim 22, wherein the text acquisition interface comprises the text entry interface.

24. The method of claim 22, wherein the text acquisition interface comprises the text selection interface.

25. A computer program product for facilitating a user in generating an asset-descriptive electronic document comprising a first image having a predefined first aspect ratio and a second image having a predefined second aspect ratio differing from the predefined first aspect ratio, the computer program product tangibly embodied in a non-transitory computer readable storage medium and comprising instructions executable by at least one processor comprising at least a processor of a mobile computing device comprising a touchscreen and a digital camera, to implement a method comprising:
displaying, on the touchscreen, a document generation interface enabling the user to activate a first digital camera interface and a second digital camera interface,
wherein the first digital camera interface enables the user to actuate the digital camera to capture the first image with an aspect ratio that is substantially equal to the predefined first aspect ratio, and comprises a first digital camera live view area having an aspect ratio that is substantially equal to the first predefined aspect ratio; and
wherein the second digital camera interface enables the user to actuate the digital camera to capture the second image with an aspect ratio that is substantially equal to the predefined second aspect ratio, and comprises a second digital camera live view area having an aspect ratio that is substantially equal to the second predefined aspect ratio; and
displaying the first digital camera interface, and in response to the user actuating the digital camera using the first digital camera interface, capturing the first image;
displaying the second digital camera interface, and in response to the user actuating the digital camera using the second digital camera interface, capturing the second image; and
generating and storing the asset-descriptive electronic document comprising the first image or an image based thereon, and the second image or an image based thereon.

26-27. (canceled)

28. A system for facilitating a user in generating an asset-descriptive electronic document comprising a first image having a predefined first aspect ratio and a second image having a predefined second aspect ratio differing from the predefined first aspect ratio, the system comprising a mobile computing device comprising a touchscreen and a digital camera, a processor comprising at least a processor of the mobile computing device, and at least one non-transitory computer readable storage medium comprising instructions executable by at least one processor to implement a method comprising:
displaying, on the touchscreen, a document generation interface enabling the user to activate a first digital camera interface and a second digital camera interface,
wherein the first digital camera interface enables the user to actuate the digital camera to capture the first image with an aspect ratio that is substantially equal to the predefined first aspect ratio, and comprises a first digital camera live view area having an aspect ratio that is substantially equal to the first predefined aspect ratio; and
wherein the second digital camera interface enables the user to actuate the digital camera to capture the second image with an aspect ratio that is substantially equal to the predefined second aspect ratio, and comprises a second digital camera live view area having an aspect ratio that is substantially equal to the second predefined aspect ratio; and
displaying the first digital camera interface, and in response to the user actuating the digital camera using the first digital camera interface, capturing the first image;
displaying the second digital camera interface, and in response to the user actuating the digital camera using the second digital camera interface, capturing the second image; and
generating and storing the asset-descriptive electronic document comprising the first image or an image based thereon, and the second image or an image based thereon.

29-30. (canceled)

31. A method for facilitating a user in generating an asset-descriptive electronic document comprising a first image having a predefined first aspect ratio and a second image having a predefined second aspect ratio differing from the predefined first aspect ratio, the method implemented by a processor comprising at least a processor of a mobile computing device comprising a touchscreen and a digital camera, the method comprising:
displaying, on the touchscreen, a document generation interface enabling the user to activate a first digital camera interface and a second digital camera interface,
wherein the first digital camera interface enables the user to actuate the digital camera to capture the first image with an aspect ratio that is substantially equal to the predefined first aspect ratio, and comprises a first digital camera live view area having an aspect ratio that is substantially equal to the first predefined aspect ratio; and
wherein the second digital camera interface enables the user to actuate the digital camera to capture the second image with an aspect ratio that is substantially equal to the predefined second aspect ratio, and comprises a second digital camera live view area having an aspect ratio that is substantially equal to the second predefined aspect ratio; and
displaying the first digital camera interface, and in response to the user actuating the digital camera using the first digital camera interface, capturing the first image;
displaying the second digital camera interface, and in response to the user actuating the digital camera using the second digital camera interface, capturing the second image; and
generating and storing the asset-descriptive electronic document comprising the first image or an image based thereon, and the second image or an image based thereon.

32-33. (canceled)
